(19) United States
(12) Patent Application Publication
(10) Pub. No.: US 2012/0305812 A1
(43) Pub. Date: Dec. 6, 2012

(54) SPECT TARGETED VOLUME MOLECULAR IMAGING USING MULTIPLE PINHOLE APERTURES

(76) Inventors: Jason D. Bowen, Los Angeles, CA (US); Youngho Seo, Dublin, CA (US)

(21) Appl. No.: 13/578,065

(22) PCT Filed: Jan. 31, 2011
(86) PCT No.: PCT/US2011/000182

§ 371 Date: Aug. 9, 2012

Related U.S. Application Data
(60) Provisional application No. 61/337,630, filed on Feb. 10, 2010.

(51) Int. Cl. G21K 1/02

(52) U.S. Cl. 250/505.1

(57) ABSTRACT

A computed tomography apparatus is provided that includes a single photon emission computed tomography (SPECT) multi-pinhole collimator, where the multi-pinhole collimator includes an aperture plate and a grid pattern of pinholes disposed in the aperture plate, and the pinholes include through-holes each having a central axis pointing at a common focal point at a finite distance from the aperture plate. The multi-pinhole collimator is disposed for radionuclide imaging using nuclear medicine therapies that include TI-201, Tc-99m, I-123, In-111 or I-131. Here, the radionuclide imaging can include brain radionuclide imaging, cardiac radionuclide imaging, bladder radionuclide imaging, thyroid radionuclide imaging, breast radionuclide imaging, prostate gland radionuclide imaging, or adrenal gland radionuclide imaging. The grid pattern includes up to 5 pinholes across the aperture plate and up to 4 pinholes down the aperture plate. The aperture plate includes a form factor having dimensions that fit into an imaging SPECT scanner.

### FIELD OF THE INVENTION

The invention relates Single Photon Emission Computed Tomography (SPECT). More particularly, the invention relates to multipinhole plate collimators for SPECT imaging.

### BACKGROUND OF THE INVENTION

Single photon emission computed tomography (SPECT) myocardial perfusion imaging (MPI) remains a critical tool in the diagnosis and treatment of coronary artery disease (CAD). However, after more than three decades of use, photon detection efficiency remains poor and unchanged. This is due to the continued reliance on parallel-hole collimators first introduced in 1964. These collimators possess poor geometric efficiency.

Coronary artery disease (CAD) is the leading cause of death and morbidity worldwide, and places a heavy economic burden on the global economy. Though progress has been made in the prevention and treatment of CAD, huge geographical disparities remain in the availability and allocation of resources for effective management of the disease. Key to improving disease outcomes is making judicious use of precious resources available. This includes employing sensitive and cost-effective testing strategies for screening patients at high risk for the disease. Remaining resources may then be directed to high risk patients and patients with known disease.

Single photon emission computed tomography (SPECT) has established itself as a successful and critical component of cost-saving measures when used to screen high risk CAD patients for medical intervention and/or referral to cardiac catheterization laboratories, and in 2008 almost 60% of nearly 18 million nuclear medicine imaging procedures were myocardial perfusion imaging (MPI) scans, with positron emission tomography (PET) MPI comprising less than 1% of all MPI procedures. Yet despite the success of SPECT, it is being challenged by ⁸²Rb-PET and most recently by coronary computed tomography angiography (CCTA). ⁸²Rb-PET offers higher diagnostic sensitivity and improved image quality in part due to its 2-3 orders of magnitude improvement in photon detection efficiency over conventional parallel-hole SPECT, and also reduced effective dose due the short half-life (76.4 s) of the ⁸²Rb radiotracer. In addition, ⁸²Rb-PET MPI has established incremental prognostic value. However, PET is significantly less cost-effective than SPECT, perhaps precluding its wide adoption as a replacement for SPECT. CCTA, on the other hand, is a significantly more sensitive and cost-effective screening procedure than SPECT MPI, though SPECT appears to retain a cost-effective advantage with patients with known disease. SPECT will also remain an alternative when use of CCTA contrast agents poses significant health risks, e.g. in patients with compromised renal systems.

Part of the reason for the improved diagnostic efficacy of ⁸²Rb-PET MPI and CCTA over SPECT MPI is the low photon detection efficiency inherent in conventional parallel-hole SPECT systems, where photon detection efficiency is the fraction of emitted photons detected by the imaging system. It is remarkable that despite over a half-century of intense research conventional SPECT photon detection efficiency remains largely unchanged. This is surprising given that the development of the gamma camera was motivated in part by the need for improved imaging efficiency in nuclear medicine studies. Prior to the development of the gamma camera, in vivo gamma ray images were performed with, e.g., highly inefficient directional counters. In 1958 a gamma camera with a single pinhole aperture was introduced in response to the shortcomings of the nuclear imaging techniques available at that time. In 1964, a multichannel, or parallel-hole, collimator was suggested as a replacement for the original single pinhole collimator for greater improvements in imaging efficiency. An early low energy, high-resolution (LEHR) parallel-hole collimator design achieved a sensitivity of 2.57×10⁻⁴ and a resolution of 1.5 cm at 10 cm. Current LEHR designs achieve superior spatial resolutions (approximately 1 mm at 10 cm) over the earliest designs, however with little change in sensitivity (<2×10⁻⁴). Significant improvements in detection efficiency may increase diagnostic sensitivity, which would in turn increase cost-effectiveness and perhaps lead to decreased dose requirements. The latter point is especially important given the current awareness of the dose burden SPECT MPI presents.

The shortcomings of conventional parallel-hole SPECT have been recognized since its inception and as early as 1978 a multipinhole collimator with seven pinhole apertures with the advantage of greater efficiency and simultaneous multiple angular sampling was investigated. Multipinhole collimator performance with application to human cardiac imaging has been qualitatively investigated recently in, and has also been extensively investigated in the context of small-animal imaging.

What is needed in the art is a multipinhole collimator that is useful for small organ and tissue applications to human myocardial perfusion imaging, where the multipinhole collimator may fit on existing SPECT cameras without any need for mechanical modifications of the SPECT camera and achieves over an order-of-magnitude increase in photon detection efficiency over LEHR parallel-hole collimators.

### SUMMARY OF THE INVENTION

To address the needs in the art, a computed tomography apparatus is provided that includes a single photon emission computed tomography (SPECT) multi-pinhole collimator, where the multi-pinhole collimator includes an aperture plate and a grid pattern of pinholes disposed in the aperture plate, and the pinholes include through-holes each having a central axis pointing at a common focal point at a finite distance from the aperture plate.

According to one aspect of the invention, the grid pattern includes up to 5 pinholes across the aperture plate and up to 4 pinholes down the aperture plate.

In another aspect of the invention, the pinhole has an aperture diameter in a range up to 8 mm.

According to a further aspect of the invention, the aperture plate is made from material that includes Tungsten, Lead, Gold, Platinum, and/or Depleted Uranium.

In one aspect of the invention, the pinholes are tapered pinholes and/or un-tapered pinholes.

According to yet another aspect of the invention, the aperture plate includes a form factor having dimensions that fit into an imaging SPECT scanner.

In a further aspect of the invention, the pinhole is disposed in an aperture plate bore, where the aperture plate bore includes a square bore and/or a cylindrical bore.

According to one aspect of the invention, the grid pattern of pinholes comprises a field of view disposed to provide a maximum coverage of a surface of a detector.

In another aspect of the invention, the size of the grid pattern of pinholes is determined according to an aspect ratio of detectors.

In a further aspect of the invention, the SPECT multi-pinhole collimator includes the pinholes, a pinhole grid size, a focal length and a bore length.

According to another aspect of the invention, the SPECT multi-pinhole collimator operates in the photon energy range of 70 keV to 365 keV.

In yet another aspect of the invention, the SPECT multi-pinhole collimator is disposed for radionuclide imaging using nuclear medicine therapies that include Tl-201, Tc-99m, I-123, In-111 or I-131. Here, the radionuclide imaging can include brain radionuclide imaging, cardiac radionuclide imaging, bladder radionuclide imaging, thyroid radionuclide imaging, breast radionuclide imaging, prostate gland radionuclide imaging, or adrenal gland radionuclide imaging.

In a further aspect of the invention, the SPECT multi-pinhole collimator is disposed for use in oncology applications.

### BRIEF DESCRIPTION OF THE DRAWINGS

FIGS. 1a-1c show schematic planar views of the collimator parameters, according to one embodiment of the current invention.

FIG. 2 shows a schematic perspective view of ray tracing through one pinhole, according to one embodiment of the current invention.

FIG. 3 shows a planar schematic view of the field of view projections of a grid array of pinholes, according to one embodiment of the invention.

FIGS. 4a-4b show wireframe perspective views of different embodiments of the invention that can include a with-septa and a without-septa embodiments.

FIG. 5 shows a 20-pinhole collimator set (2 heads) for small volume targeted view imaging including the heart and brain, according to one embodiment of the invention.

FIG. 6 shows an exemplary acquisition geometry with the head/brain in supine position and directed out of the page.

FIGS. 7a-7b show exemplary results of a PH20 projection (view 2) of the main photopeak at 140 keV with 5.67×10⁶ total counts, and centered at 124 keV with a width of 2.49 keV containing 3.03×10⁵ counts, respectively, according to one embodiment of the invention.

FIGS. 8a-8b show an example CT scan in (a) and an attenuation map derived from (a) in (b), according to one embodiment of the invention.

FIGS. 9a-9c show PH20 reconstruction without AC and SC, PH20 reconstruction with AC and no SC, and PH20 reconstruction with AC and SC, respectively, according to one embodiment of the invention.

FIG. 10 shows an image slice from a LEHR SPECT reconstruction.

FIGS. 11a-11f show PH20 images reconstructed from views with 300 s per view and 150 s per view as a function of the number of views, according to one embodiment of the invention.

FIGS. 12a-12b shows a PH20 configured to be fit on an Infinia Hawkeye 4, and results of the PH20 (solid line) and LEHR (dashed line) point source photon detection efficiencies as function of distance from the collimator center, according to one embodiment of the invention.

FIGS. 13a-3d show PH20 analytic, PH20 Monte Carlo simulated projections and LEHR analytic, LEHR Monte Carlo simulated projections.

FIGS. 14a-14f show PH20 (a) CRC, (b) standard error, and (c) CNR; and LEHR (d) CRC, (e) standard error, and (f) CNR.

FIGS. 15a-15b show (a) SNR per μCi per voxel averaged over all voxels for each patient anatomy listed in Table 2, and an analysis for a multipinhole collimator with nine pinhole apertures (dark solid line), (b) Ratios of PH20 to LEHR SNRs as a function of resolution, according to one embodiment of the invention.

FIGS. 16a-16d show (a) ROI definitions for determination of mean bias fractions (see Table 4) and NFF test slice bias maps for (b) LEHR (30 iterations of OSEM), (c) PH20, and (d) LEHR (2 iterations of OSEM). Bias fractions are scaled from 0 (white) to 1 (black).

FIG. 17 show area under the ROC curve, (AUC) as a function of resolution, where at 12.5 mm PH20 AUC is larger than the LEHR AUC with a p-value of 0.0067.

FIGS. 18a-18f. show the geometry of the perfusion defect. The angular width of the defect is 30° and spans the entire length of the LV. FIGS. 18c-18f contains reconstructed short-axis slices.show (a) Perfusion defect geometry (20% contrast). (b) Reconstructed PH20 and LEHR short-axis slices of the phantom in (a). An abnormality is present in the PH20 images. No abnormality is apparent in the LEHR images.

### DETAILED DESCRIPTION

The current invention provides focused multipinhole collimators for small volume imaging. The invention has been experimentally and mathematically proved that the same geometries of the multipinhole collimators in the current invention can be used for radionuclide imaging using nuclear medicine therapies that include TI-201, Tc-99m, I-123, In-111 or I-131. Here, the radionuclide imaging can include brain radionuclide imaging, cardiac radionuclide imaging, bladder radionuclide imaging, thyroid radionuclide imaging, breast radionuclide imaging, prostate gland radionuclide imaging, adrenal gland radionuclide imaging, cardiac radionuclide imaging or brain single photon emission computed tomography (SPECT). In a further aspect of the invention, the SPECT multi-pinhole collimator is disposed for use in oncology applications.

One aspect of the current invention includes the use of a single set of multipinhole collimators (usually 2 collimators as a set for two-head SPECT camera) for both cardiac and brain radionuclide imaging. This flexible use of the single set of multipinhole collimators for two different radionuclide imaging applications is superior to existing dedicated cardiac imaging SPECT scanners.

According to one aspect, this invention is useful in dedicated brain/cardiac multipinhole collimators for existing SPECT scanners. Further, this invention is useful as a new dedicated SPECT scanner using dedicated brain/cardiac multipinhole collimators and associated image processing software including reconstruction algorithm and scanner calibration algorithms.

According to other aspects, the invention provides cost reduction by removing the need of purchasing or developing separate dedicated collimators for cardiac and brain imaging, provides cost reduction by removing the need of purchasing a new dedicated SPECT camera that comes with dedicated cardiac or brain collimators, and enables high patient throughput by performing back-to-back brain-to-cardiac (or cardiac-to-brain) radionuclide imaging applications without having to exchange radionuclide collimators. The invention also provides a complete package of commercial solutions such as hardware design (multipinhole collimators), image reconstruction algorithms, and calibration algorithms to achieve high quality and high sensitivity (that is a intrinsic advantage of multipinhole collimators over conventional parallel-hole collimators) at a given spatial resolution comparable to existing SPECT imaging technologies.

The invention includes multipinhole collimators that can be fit into existing or future SPECT cameras for imaging that can include both brain and cardiac imaging or other targeted volumes such as prostatic bed, etc.), where associated software includes calibration techniques and image reconstruction algorithms.

A computer simulation using Monte Carlo/raytracing technique was used to model the design schemes of the current invention. And, using computer phantoms of heart and brain with custom assigned radioactivity distribution as source objects, realistic projection data for image reconstruction were acquired.

Aspects of the invention that can be varied according to application include detector-to-aperture distance, focal length, bore type (knife-edge, keel-edge, cylindrical, square, etc.), bore length, opening angle, number of pinholes, arrangements that can include hexagonal, to square, rectangular, circular, cylindrical, or other shapes that optimize the detector size and profile. In a further aspect of the invention, the pinholes are tapered pinholes and/or un-tapered pinholes. For example, the effective diameter for knife-edge pinholes is 10-15% larger than the physical diameter (photons penetrate the edges). A solution is to drill holes with no taper (cuboid or cylindrical). Increasing the number of pinholes may increase the sensitivity.

In one aspect of the invention, the size of the grid pattern of pinholes is determined according to an aspect ratio of detectors. According to another aspect of the invention, the grid pattern of pinholes comprises a field of view disposed to provide a maximum coverage of a surface of a detector.

According to the embodiment having pinholes with no taper, the aperture penetration is significantly reduced (10%-15% of detected counts), and effectively reduces bore type to square and/or cylindrical bores. The invention provides a maximum of the detector area. For rectangular detectors rectangular pinhole arrangements are provided to match the symmetry of the detector plane. The size of the grid is provided according to the fixed aspect ratio of the detectors. According to one aspect of the invention, the grid pattern includes up to 5 pinholes across the aperture plate and up to 4 pinholes down the aperture plate. According to the invention, the detector-to-aperture distance is provided such that the collimator fits on existing SPECT cameras, where the detector resolution is comparable to that achieved with parallel-hole collimators. According to an exemplary embodiment, the detector-to-aperture distance is fixed at 12.2 cm, and aperture diameters 0.45, 0.52, and 0.7 cm may be provided. The invention further provides focusing pinholes with a common focal point, which is appropriate for small volume cardiac/brain imaging for example.

For optimization of the invention, the field-of-view is back-projected through each pinhole forming shadows on the detector plane. Three exemplary designs are described below in Table 1.

The invention also provides a hardware design (multipinhole collimators), image reconstruction algorithms, and calibration algorithms to achieve high quality and high sensitivity (that is a intrinsic advantage of multipinhole collimators over conventional parallal-hole collimators) at a given spatial resolution comparable to existing SPECT imaging technologies.

Table 1 gives design parameters for three exemplary pinhole aperture sizes determined according to the method above: 0.45, 0.52, and 0.70 cm (all dimensions are given in cm). These results are then assumed valid for cylindrical and knife-edge pinholes (with corresponding opening angle).

TABLE I
SELECTED 20-PINHOLE COLLIMATOR DESIGNS

| Parameters (cm) | Design A | Design B | Design C |
|---|---|---|---|
| S | 0.45 | 0.52 | 0.70 |
| H | 5.82 | 6.32 | 6.20 |
| F | 35.0 | 39.6 | 39.0 |
| L | 0.725 | 0.80 | 1.09 |

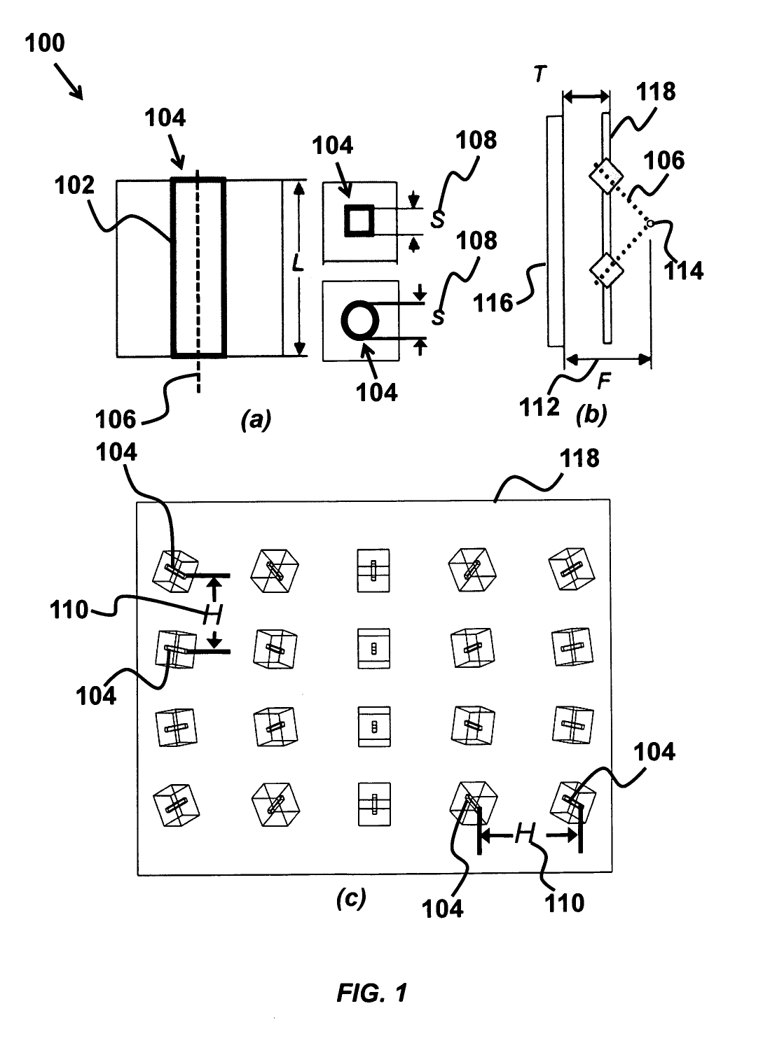

Referring now to the drawings, FIGS. 1a-1c show schematic planar views of the collimator parameters 100, where shown is L=bore length 102 of the pinhole 104 having a central axis 106, S=diameter 108 of the pinhole 104, H=separation 110 between pinholes 104, F=focal length 112 (focal point 114 to detector 116 distance), and T=separation of the aperture plate 118 to the detector 116. FIG. 1b shows a schematic view of the alignment of the pinholes 104 having a central axis 106 pointing at a common focal point 114 at a finite distance from the aperture plate 118. FIG. 1c shows the aperture plate 118 and a grid pattern of pinholes 104, where the pinholes 104 have through-holes 102 each having a central axis 106 pointing at a common focal point 114 at a finite distance (F-T) from the aperture plate 116. According to one aspect, the aperture plate 118 can be made from material that includes Tungsten and/or Depleted Uranium.

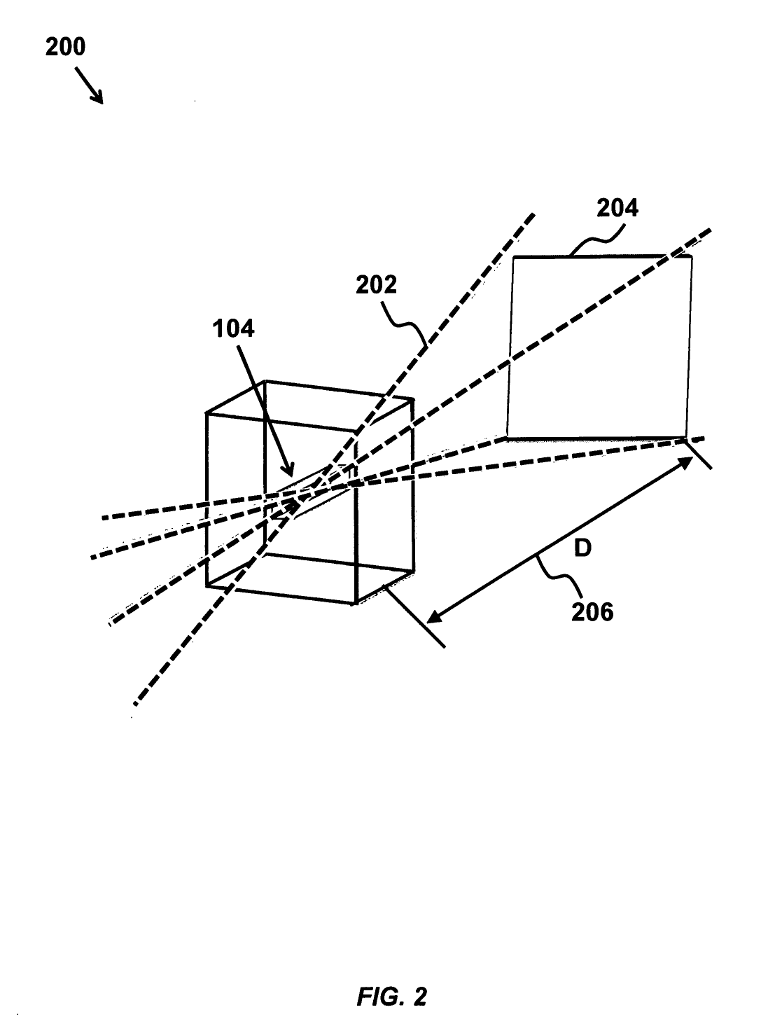

FIG. 2 shows a perspective ray tracing diagram 200 through one pinhole 104, according to one embodiment of the current invention. Here, the rays 202, for example from a SPECT scanner, provide a field of view 204 at a finite distance 206 from the pinhole 104.

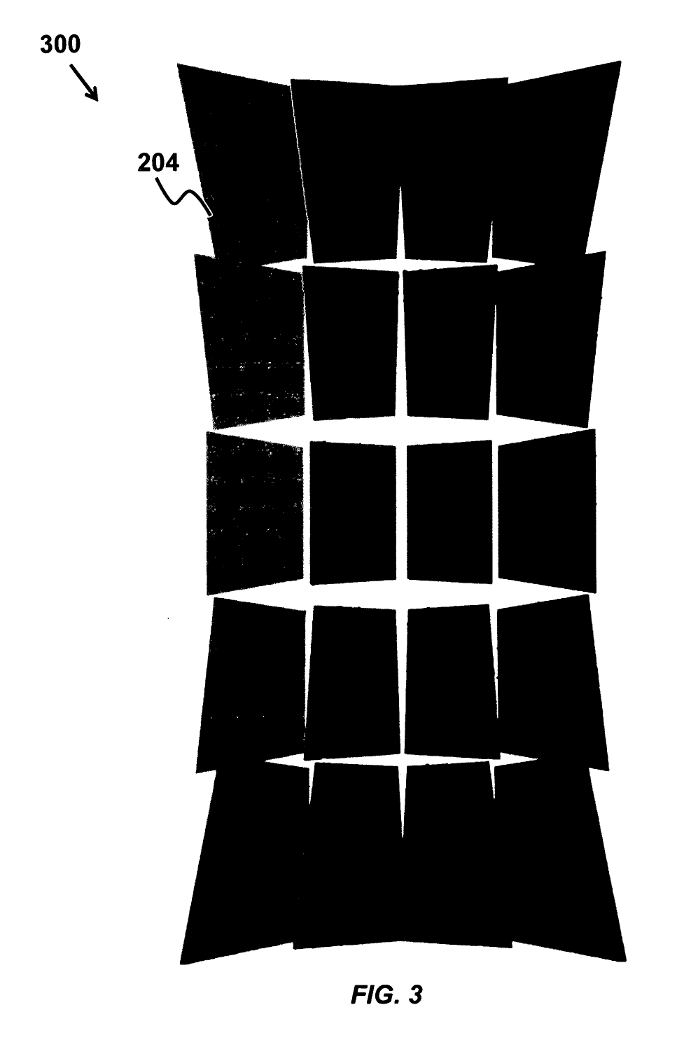

FIG. 3 shows a planar schematic view of a grid pattern of projections 300 of the field of view 204 from light passing through a grid pattern of pinholes 104, for example the 4×5 array shown in FIG. 1c, according to one embodiment of the invention.

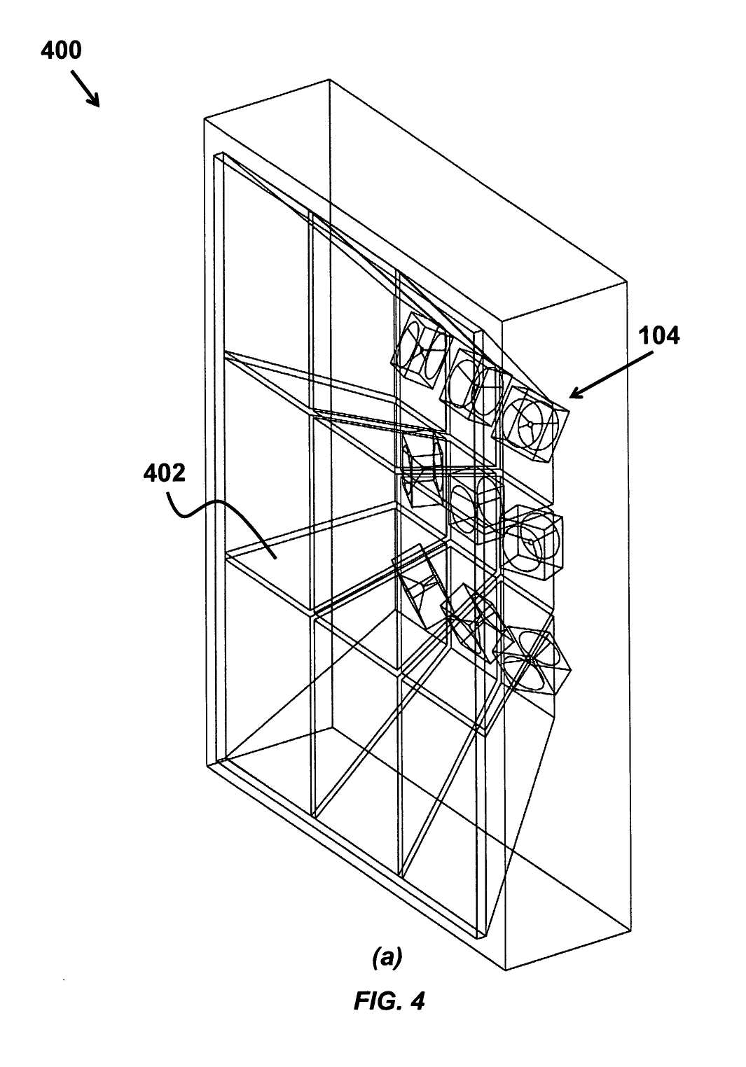

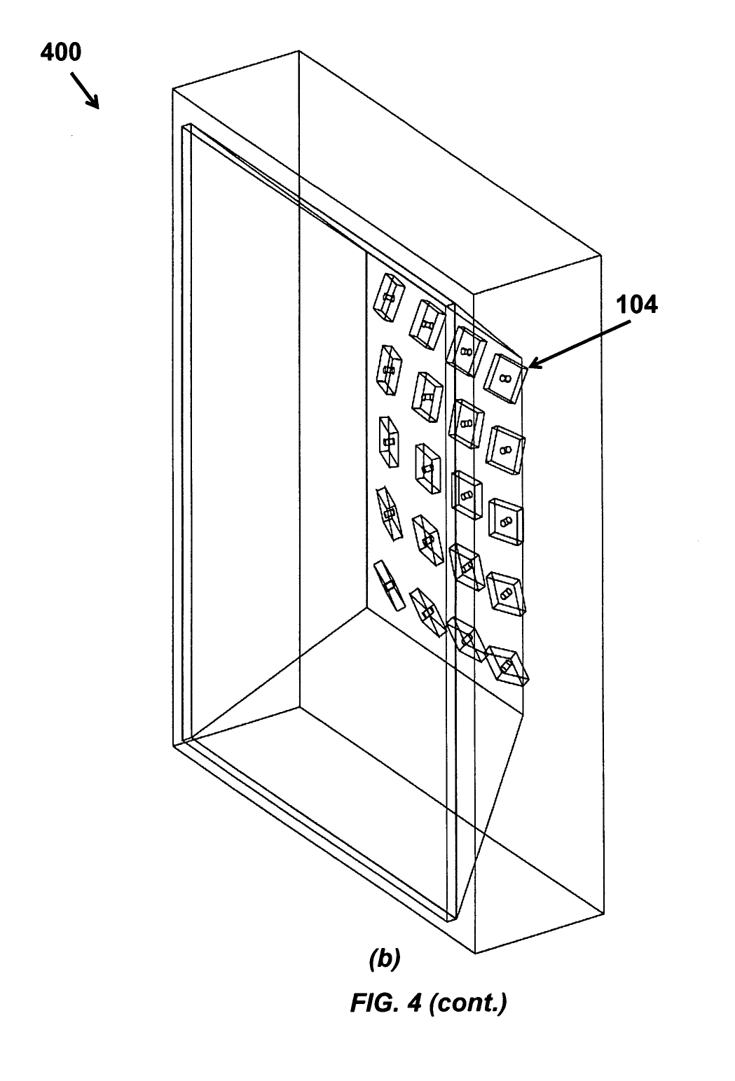

FIGS. 4a-4b show wireframe perspective views of different embodiments of the multi-pinhole apertures 400 that can include one embodiment with septa 402 between each pinhole 104 and one without septa.

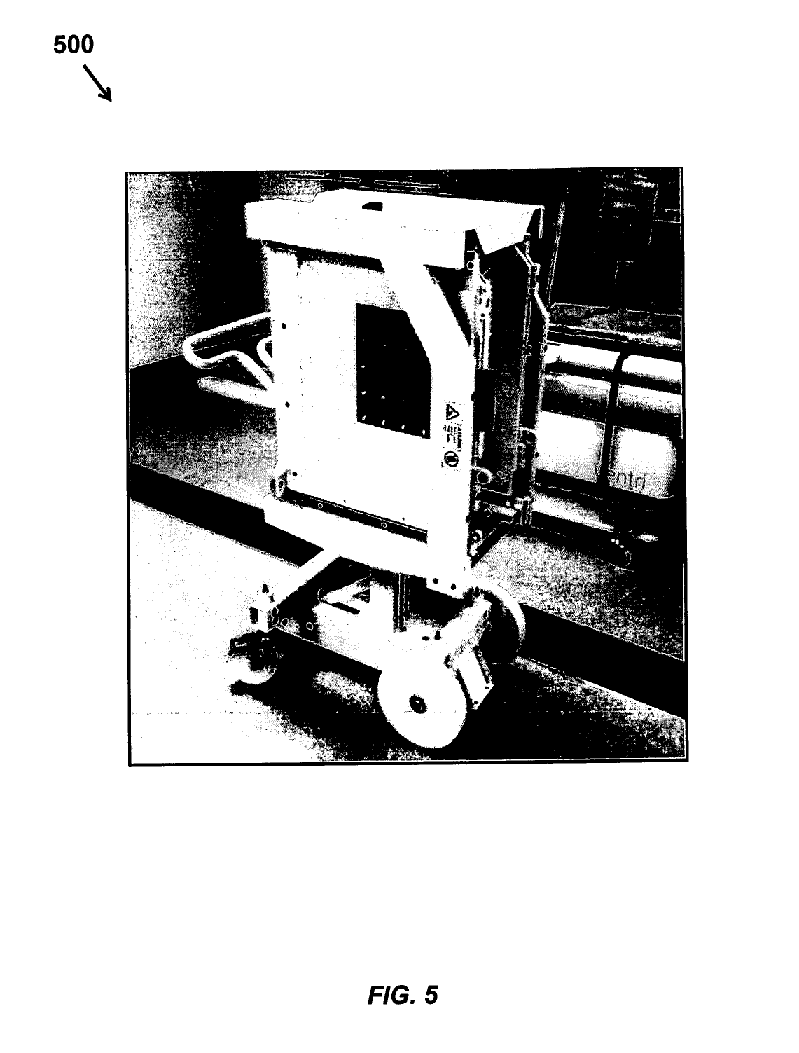

FIG. 5 shows a set of two 20-pinhole collimators 500 for small volume targeted view imaging including the heart and brain. An exemplary multipinhole collimator evaluation is provided that is used for brain single photon emission computed tomography (SPECT) imaging by assessing the relative image quality as a function of the number of projections and acquisition time. Images were also compared to an image obtained from a conventional low energy high resolution (LEHR) parallel-hole collimator.

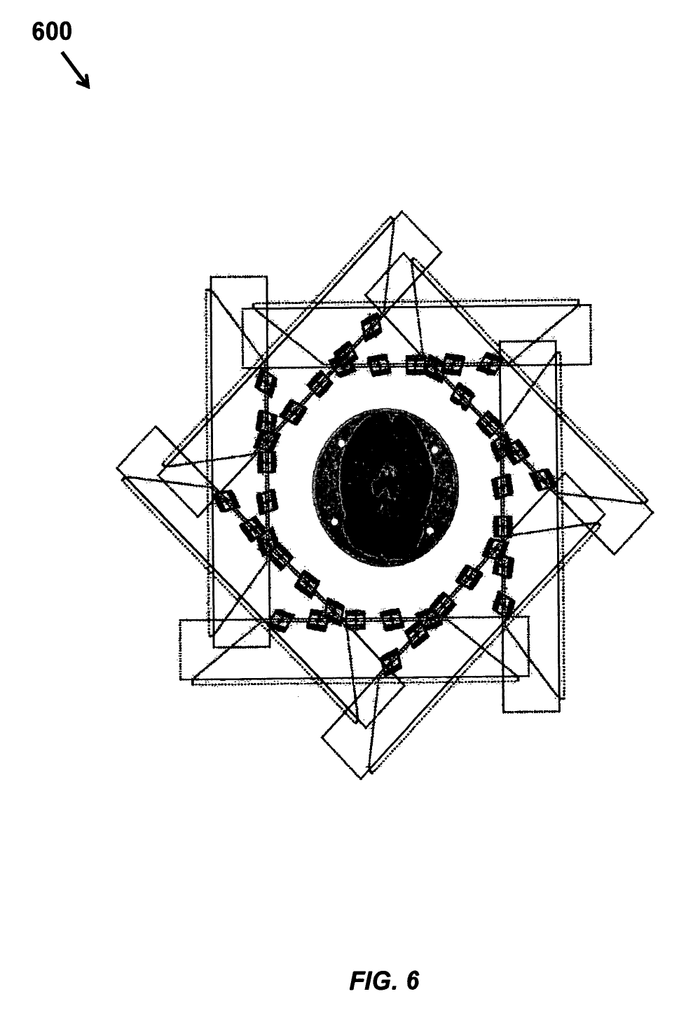

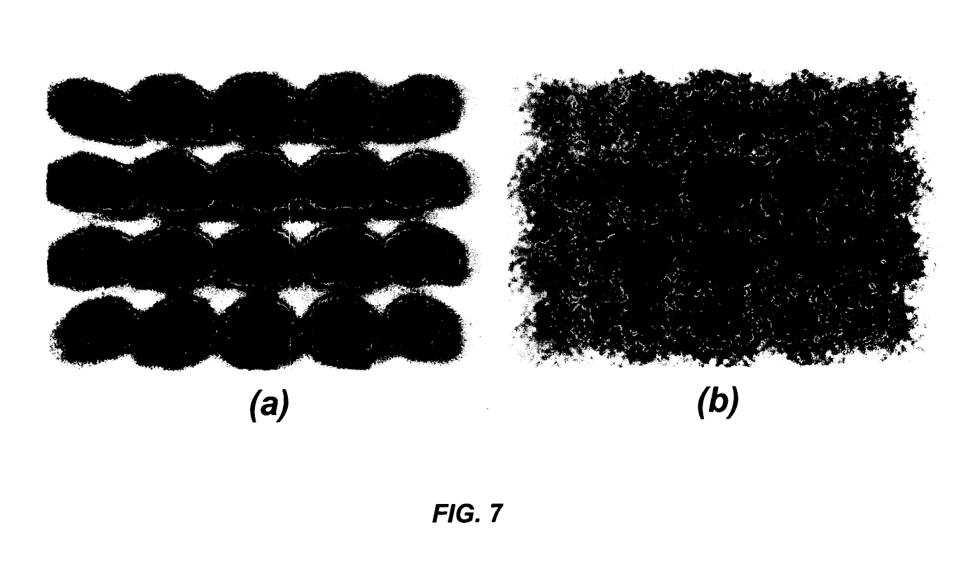

FIG. 6 shows the acquisition geometry 600 according to one aspect of the invention. The head/brain is supine and is directed out of the page. The angle of rotation is 45°. The SPECT protocol included 4 stops and 300 s/view with a 360° orbit (21.4 cm radius-of-rotation) followed by low-mA CT. Images from a 20-pinhole grid array collimator (PH20), according to one embodiment as shown in FIG. 4b, were reconstructed with 300 iterations of MLEM without any prefiltering of the projection data. Projection data can be taken for several windows as shown in FIGS. 7a-7b for the main energy window centered at 140 keV and a lower energy window centered at 124 keV. Limited views (4 and 2 views) were also reconstructed. Reduced acquisition time was simulated by reducing the counts in projection bins by ½ followed by addition of Poisson noise. The images were CT-based attenuation corrected (AC) and triple-energy-window (TEW) scatter corrected (SC) followed by postfiltering with a Butterworth filter (order 10 and 0.5 cutoff frequency). According to another aspect of the invention, the SPECT multi-pinhole collimator operates in the photon energy range of 70 keV to 365 keV.

As shown in FIG. 7a, a PH20 projection (view 2) of the main photo-peak is provided at 140 keV with 5.67×10⁶ total counts. The largest bin contains 1928 counts. FIG. 7b shows a PH20 projection (view 2) centered at 124 keV with a width of 2.49 keV containing 3.03×10⁵ counts. The largest bin contains 96 counts. This is not a projection of b_{d} but of C^{(left)}_{d}.

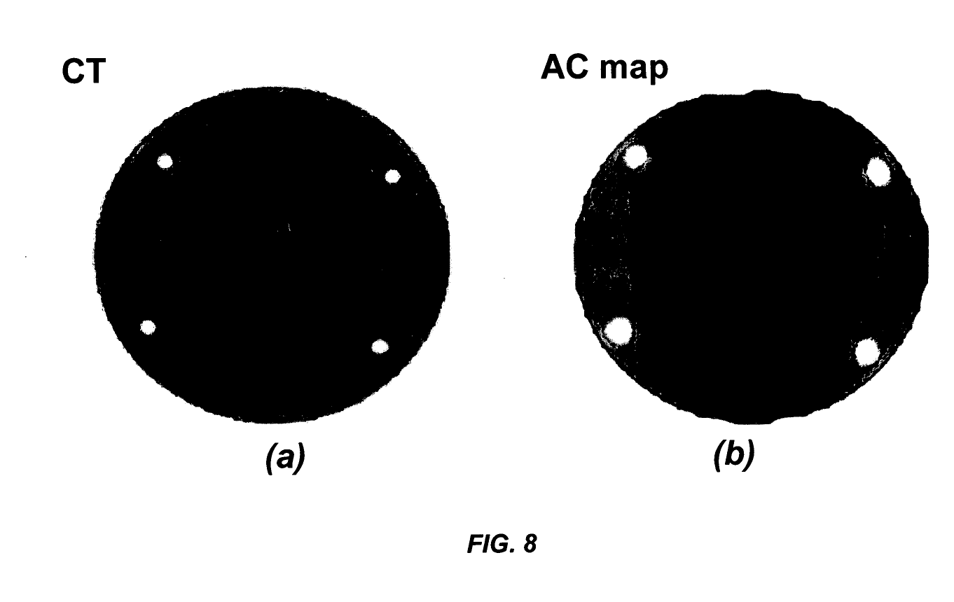

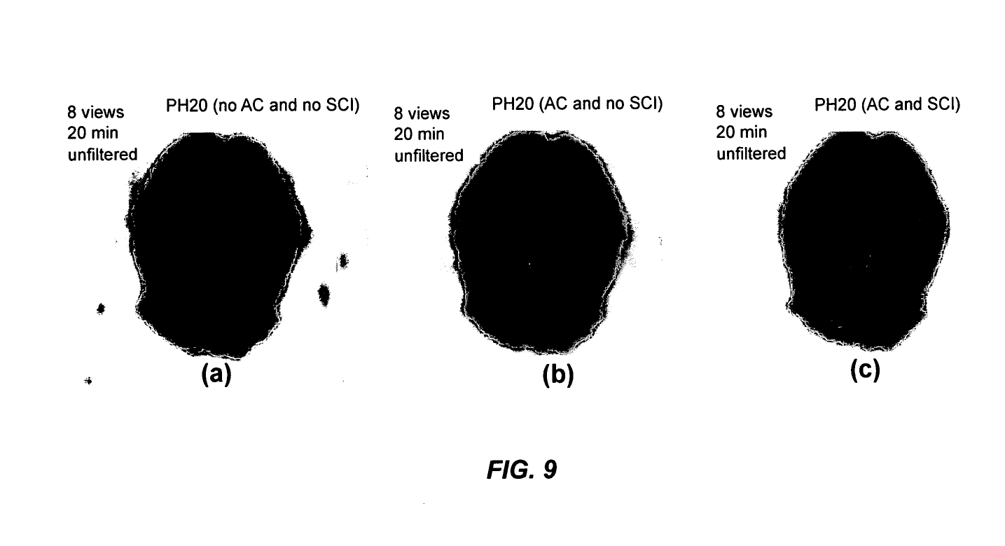

AC is built into the system matrix during its generation. During the backprojection process rays are line-length weighted and attenuated. This method requires an attenuation map, which can be derived from a CT image. FIGS. 8a-8b show a section of the CT image and CT-based attenuation map used for the AC corrections. SC is implemented using the TEW technique. Using this technique background counts, b_{d}, in the ^{99m}Tc 140 keV energy window (28 keV width) due to scatter are estimated for each projection bin:

$${b}_{d} = ( \frac{{C}_{d}^{( left )}}{{W}_{s}} + \frac{{C}_{d}^{( right )}}{{W}_{s}} ) \frac{{W}_{m}}{2}$$

where C^{(left)}_{d} and C^{(right)}_{d} are counts in the left and right neighboring window, respectively, and Wₛ and Wₘ are the widths of the neighboring and main windows, respectively. Here Wₛ is 2.49 keV wide and C^{(right)}_{d} and is taken to be zero. A projection of C^{(left)}_{d} is shown in FIG. 7b. b_{d} was filtered with a 3-point 2D median filter in this work following its determination. The median filtered b_{d} can then be corrected with an empirically determined (e.g. from Monte Carlo simulations) correction factor. A global factor of 1.1 was used here. SC is then implemented iteratively into the MLEM algorithm:

$${x}_{k}^{( n + 1 )} = \frac{{x}_{k}^{( n )}}{{s}_{k}} [ {\sum }_{d = 1}^{D} \frac{{n}_{d}}{{b}_{d} + {P}_{db} {x}_{b}^{( n )}} {P}_{dk} ]$$

where x are the image voxels, sₖ is the photon detection efficiency of voxel k, n_{d} is the number of counts in projection bin d, and P is the system matrix. D is the total number of projection elements. FIGS. 9a-9c show the relative improvements in reconstruction image quality with the successive application of AC and SC.

FIG. 9a shows a PH20 reconstruction without AC and SC, FIG. 9b shows a PH20 reconstruction with AC and no SC, and FIG. 9c shows PH20 reconstruction with AC and SC. The incremental improvement with additional corrections is apparent. These data suggest AC and SC may not be needed for some applications, though the addition of AC significantly improves reconstructed image quality. SC provides further enhancements.

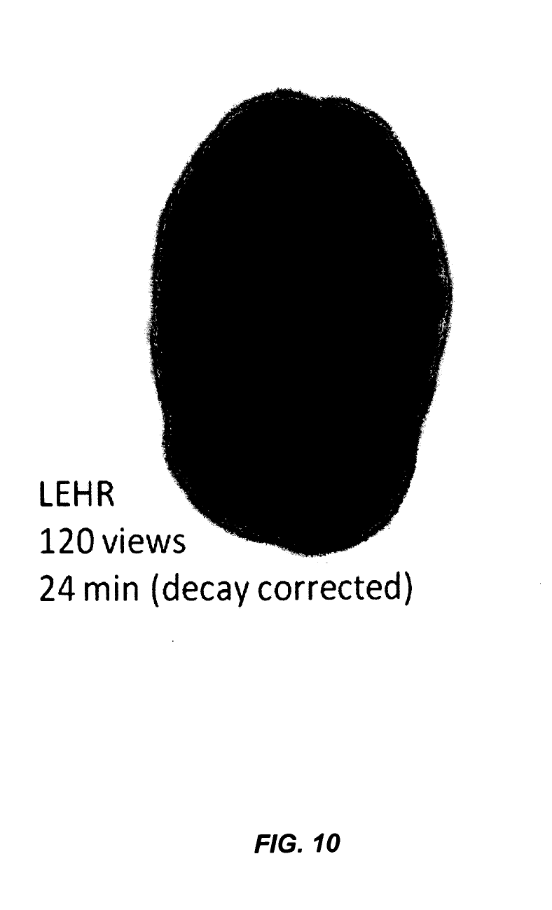

The LEHR SPECT (60 stops and 30 s/view) image (FIG. 10) was reconstructed with 2 iterations of OSEM (10 subsets). This image was also CT-based attenuation corrected and scatter corrected and postfiltered with a Butterworth filter (order 10 and 0.5 cutoff frequency).

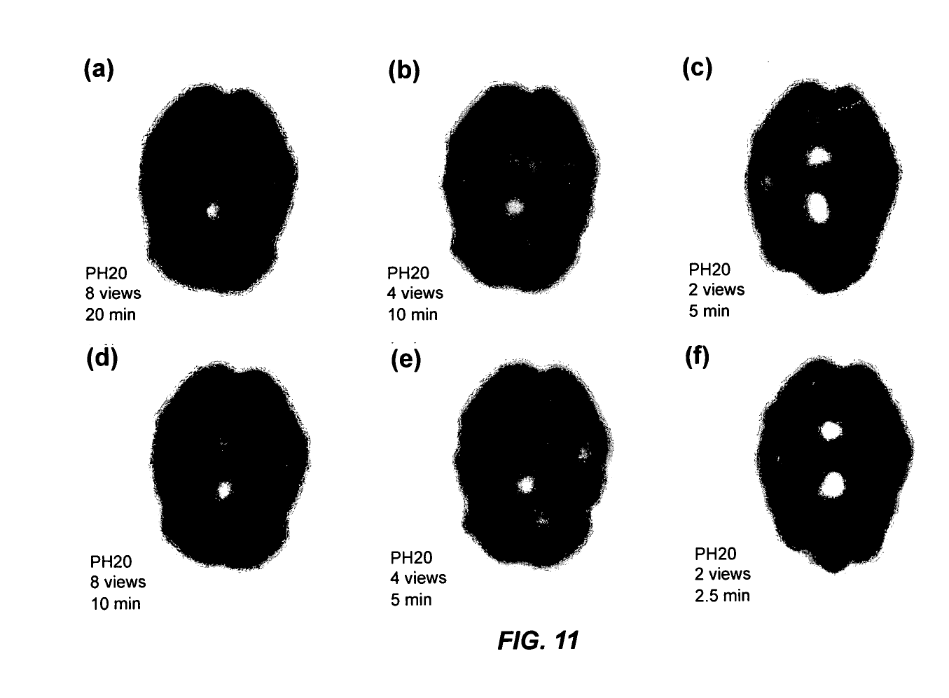

FIGS. 11a-11e show PH20 images reconstructed from views with 300 s per view and FIGS. 11d-11f show 150 s per view as a function of the number of views. All times listed are the total acquisition times for the imaging sessions.

FIGS. 11a-11f contain the major results of this exemplary demonstration. The PH20 photon detection efficiency is larger by a factor of 11, and the 8-view PH20 images demonstrate improved contrast relative to the LEHR image and are qualitatively similar. This holds even when the observation time is reduced by 50%, though some increase in bias is apparent. The same observation holds for 4-view and 2-view images, however increased bias is observed especially in the posterior parts of the brain.

The PH20 SPECT images are qualitatively similar to the LEHR SPECT derived image, implying significant acquisition time reduction and stationary operation of dynamic brain SPECT are possible. Moreover resolution is comparable (or even better) even though the 7.5 mm diameter pinhole aperture size is rather large. In one aspect of the invention, the pinhole can have an aperture diameter in a range of 4 mm to 7.5 mm.

In another example, the performance evaluation results of one embodiment of the PH20 for commercial SPECT systems are presented. Provided are computer simulations and numerical observer studies to assess the noise, bias and diagnostic imaging performance of a PH20 collimator in comparison with those of a low energy high resolution (LEHR) parallel-hole collimator. Ray-driven projector/backprojector pairs were used to model SPECT imaging acquisitions, including simulation of noiseless projection data and performing MLEM/OSEM image reconstructions. Poisson noise was added to noiseless projections for realistic projection data. Noise and bias performance were investigated for five mathematical cardiac and torso (MCAT) phantom anatomies imaged at two gantry orbit positions (19.5 cm and 25.0 cm). PH20 and LEHR images were reconstructed with 300 MLEM iterations and 30 OSEM iterations (10 subsets), respectively. Diagnostic imaging performance was assessed by a receiver operating characteristic (ROC) analysis performed on a single MCAT phantom; however, in this case PH20 images were reconstructed with 75 pixel-based OSEM iterations (4 subsets). Four PH20 projection views from two positions of a dual-head camera acquisition and sixty LEHR projections were simulated for all studies. At uniformly-imposed resolution of 12.5 mm, significant improvements in SNR and diagnostic sensitivity, represented by the area under the ROC curve, (AUC), were realized when PH20 collimators are substituted for LEHR parallel-hole collimators. SNR improves by factors of 1.94-2.34 for the five patient anatomies and two orbital positions studied. For the ROC analysis the PH20 AUC is larger than the LEHR AUC with a p-value of 0.0067. Bias performance, however, decreases with the use of PH20 collimators. Systematic analyses showed PH20 collimators present improved diagnostic imaging performance over LEHR collimators, requiring only a collimator exchange on existing SPECT cameras for their use.

Presented are detailed simulation performance test results of the PH20 collimator in comparison to a LEHR parallel-hole collimator for the purposes of investigating the effect of increased efficiency and simultaneous angular sampling on noise performance and diagnostic sensitivity. Further presented are task-based and voxel-based performance assessments of image quality. Task-based assessment of a classification task is defined as a receiver operating characteristic (ROC) analysis of tasks involving human or numerical observers emulating human performance. These studies provide absolute quantification of the diagnostic capabilities of imaging systems, according to one embodiment of the current invention. Voxel-based assessments examine noise, resolution, and bias properties of images and are a useful alternative or complement to task-based assessments. In this example the signal-to-noise ratio (SNR), bias, and the area under the ROC curve (AUC) are presented as a function of resolution as performance metrics for LEHR and PH20 SPECT imaging systems.

A matched projector/backprojector pair derived from ray-driven techniques is used to assess PH20 and LEHR collimator performance. Collimator geometry, depth-dependent blur, and attenuation are modeled in the projector. Compton scatter and detector response (including the effects finite position resolution, photon penetration, and parallax) are ignored. Six configurations of a dual-head SPECT camera system with circular movement of the collimator heads are modeled for estimation of noise properties for both PH20 and LEHR systems. Each configuration is defined by the gender and cardiac geometry of the digital phantom, and the radius-of-rotation (ROR) of the gantry orbit. The mathematical cardiac and torso phantom (MCAT) was used exclusively in this work as a digital model simulating patient anatomies and radioactive tracer distributions. The configurations studied for noise assessment include: a male torso with an average size heart at 19.5 cm ROR (NMN), a female torso with an average size heart at 25.0 cm ROR (NFF), a male torso with a small heart at 19.5 cm ROR (SMN), a female torso with a small heart at 25.0 cm ROR (SFF), and a female torso with a large heart at 25.0 cm ROR (LFF). The female torso contains breast tissue simulating the presence of additional attenuating matter encountered, e.g., when imaging large or obese patients. Large and small heart sizes reflect heart sizes 20% larger and 20% smaller than normal, respectively, as defined in the MCAT phantom. Table 2 contains a summary of the properties of the anatomic models investigated. Only the NFF geometry was studied for the task-based assessment.

TABLE 2

| Model | Heart Size (a) | Breast Tissue (b) | ROR (cm) (c) | LV Voxels (d) |
|---|---|---|---|---|
| NMN | +0 | N | 19.5 | 106 |
| NFF | +0 | Y | 25.0 | 106 |
| SMN | −20 | N | 19.5 | 74 |
| SFF | −20 | Y | 25.0 | 74 |
| LFF | +20 | Y | 25.0 | 148 |
| NMF | +0 | N | 25.0 | 106 |

(a) % change relative to normal MCAT size
(b) N—no; Y—yes
(c) radius-of-rotation for a circular orbit
(d) number of voxels in image slice studied for voxel-based assessment

Given a real object, Λ, and an imaging system, Θ, an image of the object can be obtained. The derived or reconstructed image is denoted as \hat{λ}. (\hat{λ} may also be interpreted as an estimator.) Then the imaging system is described mathematically as a mapping Θ:Λ→\hat{λ}. Λ is the object or the object space (depending on the context) and λ is the noiseless reconstructed image or image space. In reality Λ is a continuous variable; however it is convenient to discretize Λ (and λ) into 64×64×64 cubic volume elements, or voxels, with sides of length 6.25 mm and it is done so throughout this work. Λ is the mean activity defining a Poisson emission process and is never actually observed, however it is estimated from projection measurements. In emission tomography (e.g. PET and SPECT) the image acquisition process may be modeled as follows,

η=HΛ+ε, Eq. 1

where η and ε are vectors and H is the projector, or system matrix. The backprojector is then H^{T} are the projection measurements and ε are the estimated background counts in η (taken to be identically zero in this investigation), e.g. due to scatter. Equation 1 is the projection operation (for ε≡0) and is the basis of our simulations, i.e. given H and Λ, η can be obtained numerically. It is important to note that η denotes noiseless projection data and \hat{η} denotes noisy data and are obtained by adding Poisson noise to η. \hat{η} is a vector of random variables. Subscripted variables denote the contents of projection bins or voxels in object or image space.

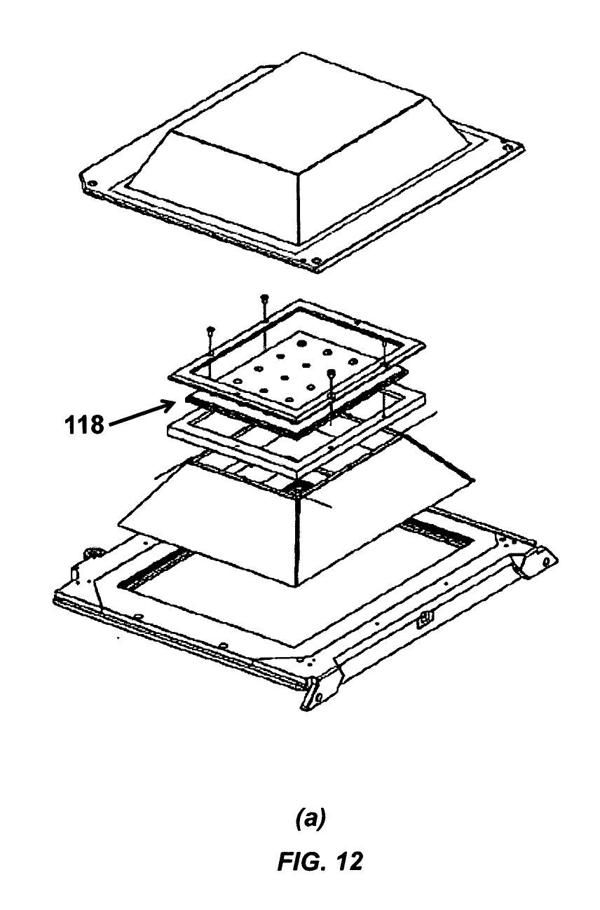

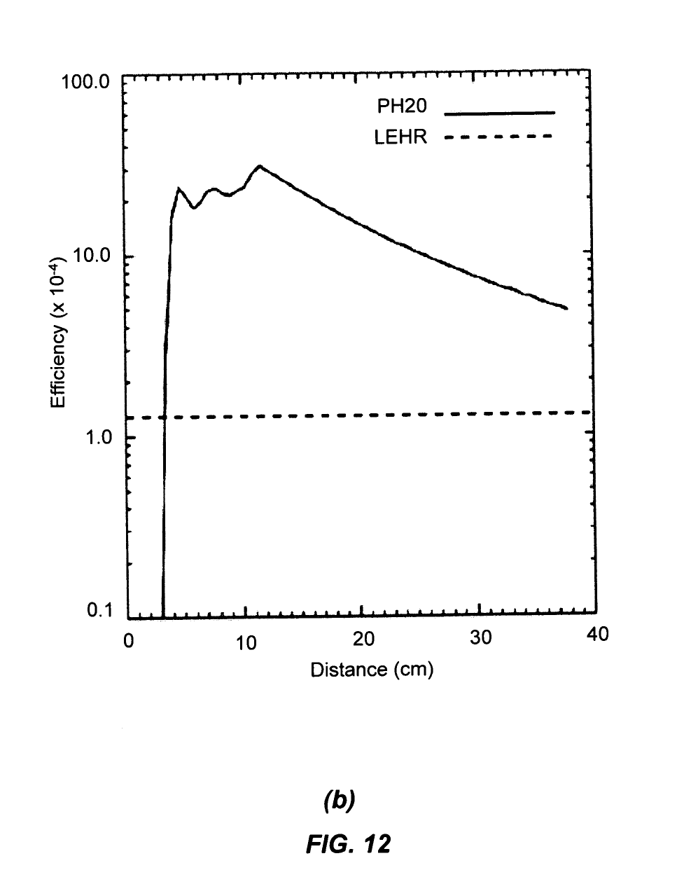

The system matrix encodes the number of projection views, angle of rotation (AOR), radius of rotation (for a circular gantry orbit), patient anatomy (in the form of an attenuation map), and pinhole geometry including the layout of the pinholes on the aperture plate. Each of the configurations listed in Table 2 are imaged with four PH20 (45° AOR) and sixty LEHR (3° AOR) projection views. The projection views are discretized into 128×128 square projection bins, or pixels, with sides of length 0.44 cm. The exemplary 0.75 cm diameter PH20 apertures 118 are arranged on a 5×4 rectangular grid, as shown in FIG. 12 a, with 6.2 cm spacing in the long dimension and 5.8125 cm spacing in the short dimension and 32.7° half-opening angle. The detector-to-pinhole distance is 12.2 cm. The LEHR collimator includes circular holes with diameter 0.119 cm and length 1.875 cm. The distance between the detector surface and the LEHR collimator is 0.75 cm. Since the LEHR collimator performs an approximate Radon transform of the radioactivity distribution, the object space was reduced in size to 64×64×20 voxels to speed up the simulations. This size reduction has a negligible effect on the core results of this example.

System matrices for the six configurations listed in Table 2 for both PH20 and LEHR SPECT imaging systems were generated. 25 mCi of ^{99m}Tc-sestamibi (140 keV) was simulated for the voxel-based assessment and distributed throughout the phantoms according to the relative weights for each organ listed in Table 3. Table 3 also lists the percent uptake of the administered dose in each modeled organ. For the task-based assessment rest and stress protocols were simulated with 8 mCi and 25 mCi of ^{99m}Tc-sestamibi, respectively. 300 s per PH20 view and 20 s per LEHR view were simulated. Projections were then generated according to Equation 1. For realistic data Poisson noise was added and the projections were then reconstructed.

The maximum likelihood expectation maximization (MLEM) algorithm is used to estimate Λ given a set of projection measurements, \hat{η}:

$${\hat{λ}}_{k}^{( n + 1 )} = \frac{{\hat{λ}}_{k}^{( n )}}{{s}_{k}} {\sum }_{d = 1}^{D} \frac{{η}_{d}}{{ɛ}_{d} + {\sum }_{b = 1}^{B} {H}_{db} {\hat{λ}}_{b}^{( n )}} . \qquad Eq . 2$$

where n is the current image, n+1 is the image update, d and b are projection space and object space indices, respectively, and D and B are the sizes of η and Λ, respectively, sₖ is the so-called sensitivity term:

$${s}_{k} = {\sum }_{d = 1}^{D} {H}_{dk} . \qquad Eq . 3$$

The PH20 projection data used in the voxel-based analysis were reconstructed with 300 iterations of standard MLEM, i.e. Equation 2. All LEHR projection data, however, were reconstructed with 30 iterations of the ordered subsets expectation maximization (OSEM) algorithm with 10 subsets, and the PH20 images analyzed in the task-based analysis were reconstructed with 4 subsets of pixel-based OSEM. OSEM requires the partitioning of the projection data into M groupings, or subsets, Sₘ, where 1≦m≦M. Each subset, η_{d}εSₘ, is treated as independent data and processed sequentially according to Equation 2 with the updated image of one subset serving as input into the next subset. An iteration is completed when all subsets have been processed. This technique achieves an acceleration factor approximately equal to the number of subsets.

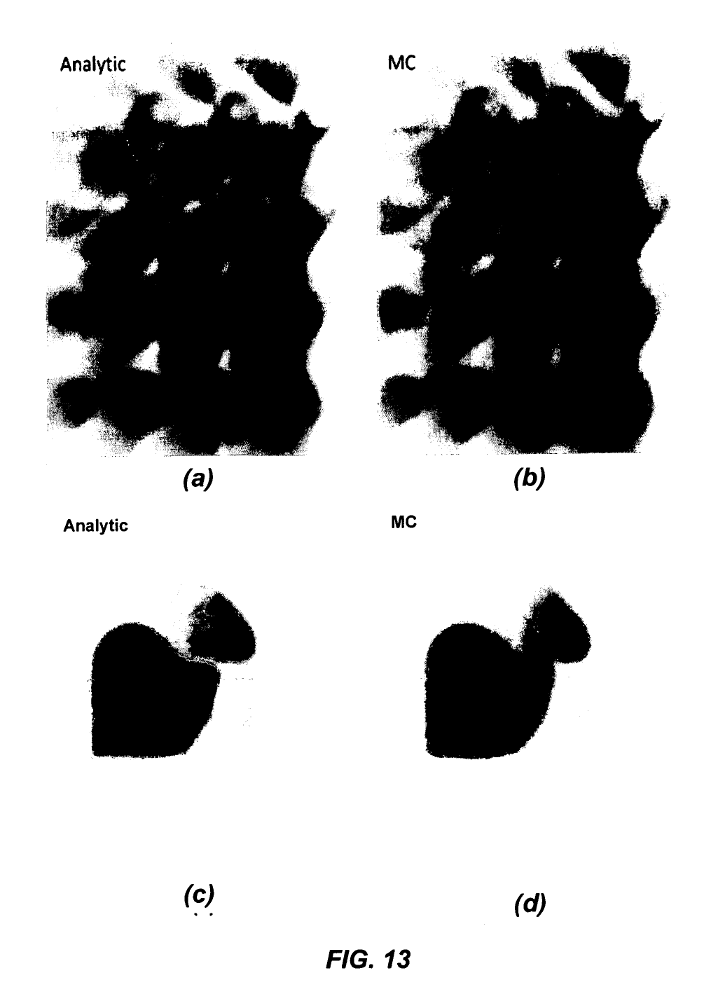

The projector/backprojector pair is used to both simulate projection data and to perform image reconstruction. Given the importance of the projector/backprojector pair in this example, it is critical to verify that it produces realistic results. FIGS. 13a-13d compare projection data obtained from MGEANT Monte Carlo (MC) simulations and analytic results. Normalizations are within 30% for the PH20 and LEHR data sets.

MC simulations were also used to estimate organ specific count rates in the ^{99m}Tc energy window (20%) at 140 keV. In these MC simulations a MCAT generated radioactivity distribution within an elliptical water phantom matching the dimensions of the MCAT phantom (12.5 cm and 18.5 cm semiminor and semimajor axis lengths, respectively, and 40 cm axial length) was simulated. Count rates as a function of orbit position on a circular orbit of radius 19.5 cm are given in Table 3. The advantage PH20 SPECT affords is increased photon detection and so care must be exercised to ensure count rates are within the tolerances of the SPECT camera. A 20% loss in counts is expected at 300 kcps per head for the Infinia Hawkeye 4 SPECT/CT camera (GE Healthcare, St. Chalfont, UK).

TABLE 3

| | % total | relative | | | | 45.0° | | 90.0° | | 135° |
|---|---|---|---|---|---|---|---|---|---|---|
| | activity | weight^{a} | −22.5° | 0.0° (LL) | 22.5° | (LAO) | 67.5° | (A) | 112.5° | (RAO) |
| body^{b} | 22.4 | 2 | 31184 | 30981 | 30652 | 30772 | 31347 | 31863 | 33201 | 34308 |
| liver | 54.6 | 75 | 135431 | 131668 | 114213 | 85536 | 53631 | 29285 | 16846 | 16043 |
| kidneys | 8.76 | 75 | 448 | 744 | 744 | 655 | 447 | 298 | 278 | 269 |
| spleen | 4.30 | 60 | 705 | 1171 | 1643 | 1841 | 2089 | 3098 | 5564 | 5086 |
| heart^{c} | 8.35 | 75 | 16459 | 28563 | 39966 | 44606 | 40439 | 30562 | 18935 | 11896 |
| stomach | 1.62 | 10 | 941 | 1462 | 936 | 2266 | 2322 | 2096 | 1641 | 1188 |
| total | 100.03 | — | 185168 | 194660 | 189154 | 165677 | 130274 | 97202 | 76465 | 68791 |

^{a}per voxel
^{b}includes lungs and blood
^{c}myocardium

In describing voxel-based assessment of image quality, SPECT MPI requires the comparison of rest and stress images for the detection of perfusion defects. Rest images serve as approximate background-only measurements free of defects even in the presence of severe coronary artery stenosis. Detectable ischemia will be present as regions of diminished intensity in stress images relative to corresponding regions in rest images due to a reduction of coronary flow reserve (CFR) in diseased myocardial tissue. The detection task in this example is therefore approximately equivalent to the problem of extracting a signal from measurements containing background. An appropriate measure of lesion detectability in these circumstances is the signal-to-noise ratio (SNR).

The image quality of SPECT systems is characterized by examining noise properties on a per voxel basis in the image. Here, a small signal, or impulse, δΛ_{b}, is added to voxel b in the object. The object is then projected and the (noiseless) projections are reconstructed. The resulting image is denoted λ^{(δ}^{_{d}}⁾, emphasizing that this image is derived from an object with an added impulse. A corresponding image, λ, without added impulse is also obtained. Only a fraction of the impulse is recovered in b in λ^{(δ}^{_{b}}⁾ due to the finite local impulse response (LIR) function of the imaging system:

$${lir}^{( b )} ( λ ) = \frac{\partial }{\partial {Λ}_{b}} E [ \hat{λ} ( \hat{η} ( Λ ) ) ] . \qquad Eq . 4$$

Note that lir^{(b)}(λ) is a vector. The recovered impulse is λ^{(δ}^{_{b}}⁾_{b}−λ_{b}. The standard error in b, σ_{b}, is estimated from images reconstructed from 120 Poisson noise realizations of the noiseless projection data without impulse. The SNR for the added signal δΛ_{b} in voxel b is approximately (λ^{(δ}^{_{b}}⁾_{b}−λ_{b})/σ_{b}. The object is the product of the underlying radioactivity distribution and the acquisition time per view. Given the identical simulated radioactivity distribution for both PH20 and LEHR SPECT, the advantage of PH20 SPECT, according to the invention, is the 300 s acquisition time per view (cf. 20 s per view for LEHR SPECT) for a MPI study with a fixed total acquisition time of 600 s.

Image quality is characterized by the contrast-to-noise ratio (CNR):

$${CNR}_{b} = \frac{{lir}_{b}^{( b )} ( λ )}{{σ}_{b}} , \qquad Eq . 5$$

where σ_{b} is the standard error and lir_{b}^{(b)}(λ) is the contrast-recovery-coefficient (CRC). The CNR is an appropriate measure of image quality when comparing systems imaging identical objects. This is a consequence of the object appearing explicitly in the partial derivative in Equation 4. When the LIR is nearly independent of Λ_{b}, Equation 4 is approximately the recovered impulse fraction. With this interpretation of lir^{(b)} the SNR is then

$${SNR}_{b} \approx \frac{{lir}_{b}^{( b )} ( λ )}{{σ}_{b}} {δΛ}_{b} . \qquad Eq . 6$$

The CNR is then equivalent to the SNR when comparing systems imaging identical objects, due to the cancellation of δΛ_{b}. The linearity of the LIR has been investigated by the inventors for impulses of order 10⁻⁵Λ_{b} and changes in Λ_{b} by up to factors of 2 and it was found that linearity approximately holds over this range. The SNR is then a suitable image quality metric when comparing SPECT systems imaging different objects.

In practice estimating the LIR using Equation 4 requires a sufficiently large number of noisy reconstructions with and without impulse. The calculations may be simplified if the reconstruction of a noiseless projection data set is approximately equal to the mean of many noisy reconstructions, i.e. λ(η(Λ))=E[\hat{λ}(\hat{η}(Λ))]. This approximation results in the so-called linearized local impulse response (LLIR) function:

$${llir}^{( b )} ( λ ) = \frac{\partial }{\partial {Λ}_{b}} λ ( η ( Λ ) ) , \qquad Eq . 7$$

and has been shown to be an accurate approximation. (λ^{(δ}^{_{b}}⁾_{b}−λ_{b})/δΛ_{b} is an approximation of Equation 7 if δΛ_{b} is sufficiently small, and therefore (λ^{(δ}^{_{b}}⁾_{b}−λ_{b})/σ_{b} is consistently used to estimate Equation 6 in this work.

Resolution is a difficult topic in the context of nonlinear iterative reconstruction methods. However it is advantageous to compare PH20 and LEHR imaging performances at (nearly) matched resolutions. To achieve this and to simplify the interpretation of resolution it is observed that the PSF of a bias-free image resembles the post-filter. In practice bias-free images are unachievable, however can be approximately obtained with a sufficiently large number of iterations. PH20 and LEHR images are reconstructed with 300 MLEM iterations and 30 OSEM (10 subsets) iterations, respectively, and are post-filtered with an isotropic 3D Gaussian filter. Uniform and isotropic resolution is then approximately obtained. Note that in addition to defining the PSF the post-filter also reduces local fluctuations in the reconstructed images.

An objection may be raised regarding the application of this technique to images reconstructed using OSEM. The noise properties of OSEM reconstructed images are, in general, inferior to pure MLEM reconstructed images. The noise properties of MLEM and OSEM reconstructed images are compared, and it is found that the noise properties are in agreement.

Bias is a measure of reconstructed image accuracy and is an important consideration in dynamic SPECT studies requiring absolute blood flow measurements. Bias is also reflective of nonuniform resolution. Note that \hat{λ}_{b}(\hat{η}(Λ)) is an estimator of the parameter Λ_{b}, the mean activity in voxel b. A realization of \hat{λ}_{b} given noisy measurement data \hat{η} is the estimate, and in this sense \hat{λ}_{b} may be considered a random variable. Bias, B_{b}, is then

B_{b}=E[\hat{λ}_{b}]−Λ_{b}. Eq 8

For the purpose of this example, it is more convenient to consider the mean absolute percent error (MAPE), or bias fraction, as a measure of bias:

$${MAPE}_{b} = \frac{\vert {λ}_{b} - {Λ}_{b} \vert}{{Λ}_{b}} . \qquad Eq . 9$$

Equation 9 is defined on a per voxel basis and allows for the generation of bias maps, which are useful visualization tools. Equation 9 is also useful for estimating the accuracy of derived kinetic rate constants in dynamic SPECT studies, e.g. Kₗ in the one-compartment model. Kₗ (for sestamibi uptake in the myocardium) increases by approximately 15% for a CFR value of 3 limiting the required precision and accuracy of input function and time activity curve measurements.

For the receiver operating characteristic (ROC) analysis the channelized Hotelling observer was used. In this numerical observer study the template was trained with 36 Poisson noise realizations of the NFF anatomy and 3 defect locations in the left ventricular (LV) myocardium (anterior, lateral, and inferior LV walls). The defect is 120° wide and approximately 1 cm thick. Both defect-present and defect-absent noise realizations were used in the training for a total of 36×3×2=216 training sets. In addition, 216 corresponding testing sets were used in the ROC analysis. This process was repeated for PH20 and LEHR studies for a total of 864 reconstructions. The defect contrast in these studies was 20% and the simulated activities were 2 mCi and 6.24 mCi for the rest and stress studies, respectively.

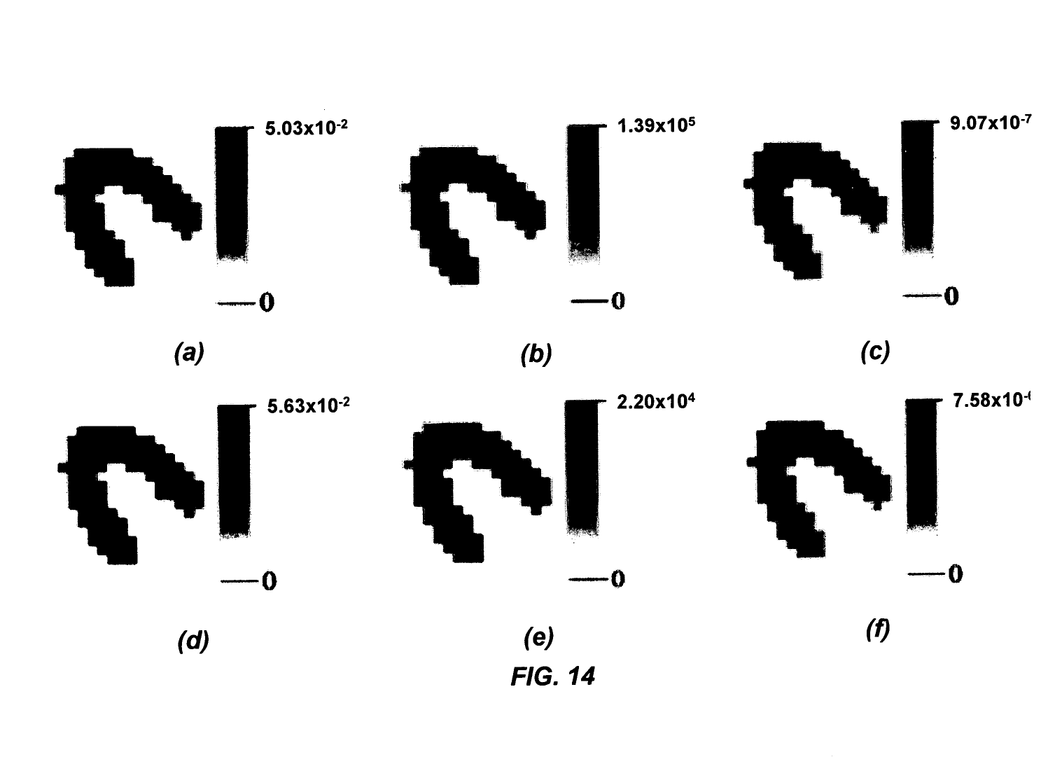

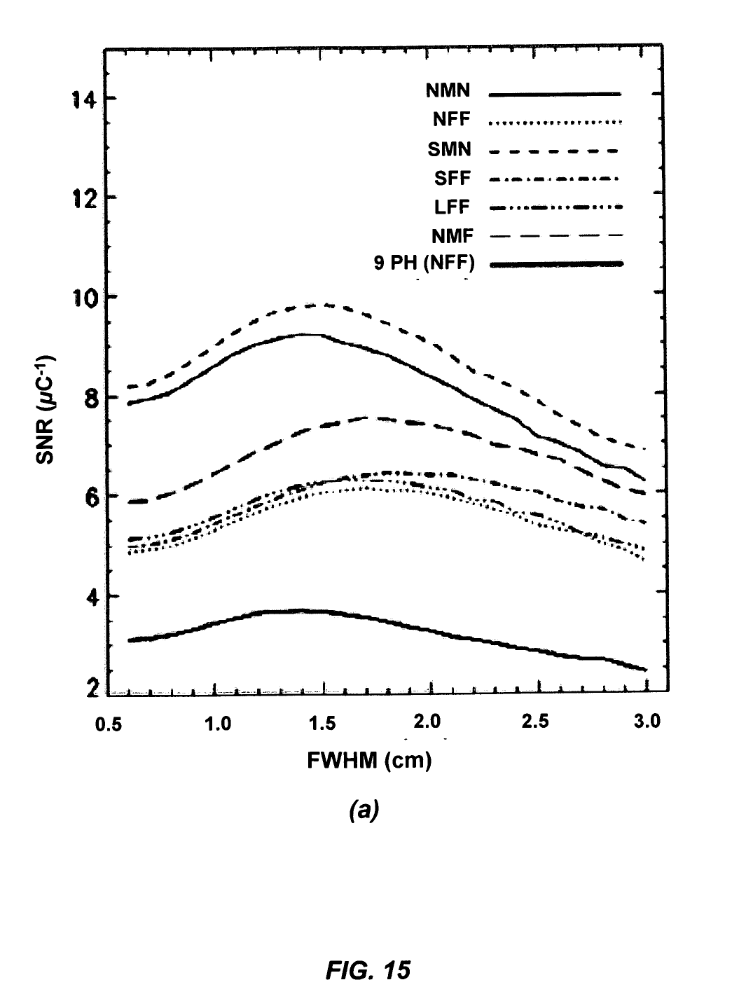

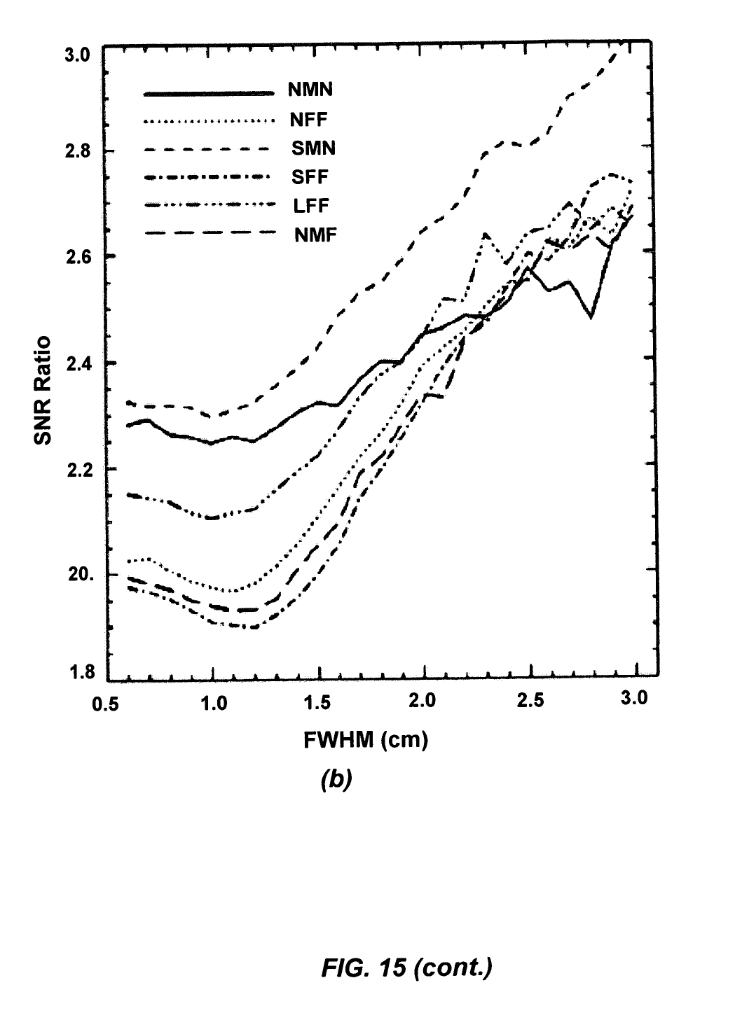

The resultant SNR was calculated for voxels in the LV wall lying within a transaxial (test) slice intersecting the PH20 and LEHR collimator centers. The number of voxels analyzed for each anatomy is listed in Table 2. For each voxel a reconstruction for the CRC and additional reconstructions of 120 noise realizations were performed for σ_{b} for a total of 614×2+120×6+6=2673 reconstructions (six noiseless reconstructions without impulse are required). FIGS. 14a-14f show CRC, σ_{b}, and CNR maps for PH20 and LEHR NFF slices. For each anatomy the mean SNR (averaged over all voxels in the test slice) is shown in FIG. 15a. The optimal resolution occurs at the local maxima; however, this may not be the desired resolution in a given application. FIG. 15b is a major result of this effort, namely, PH20 MPI has demonstrated improvement in SNR over LEHR SPECT MPI by factors of approximately 1.9-2.4 at a uniformly imposed resolution of 12.5 mm.

CRC correlates highly with resolution and a visual inspection of FIG. 14a reveals nonuniformities in resolution along the inner LV myocardium in the PH20 images, whereas resolution should be quite uniform in corresponding regions (FIG. 14d) in the LEHR reconstructed images. An examination of bias in these slices should confirm these observations.

A NFF voxel-based assessment of a multipinhole collimator with nine pinhole apertures (PH09) was also investigated. The results are shown in FIG. 15a. In this case the PH20 SNR is larger by almost 40%. FIG. 15a indicates the optimal resolution for the PH09 collimator is smaller than for the PH20 collimator. This is expected given the smaller 0.45 cm PH09 aperture diameter.

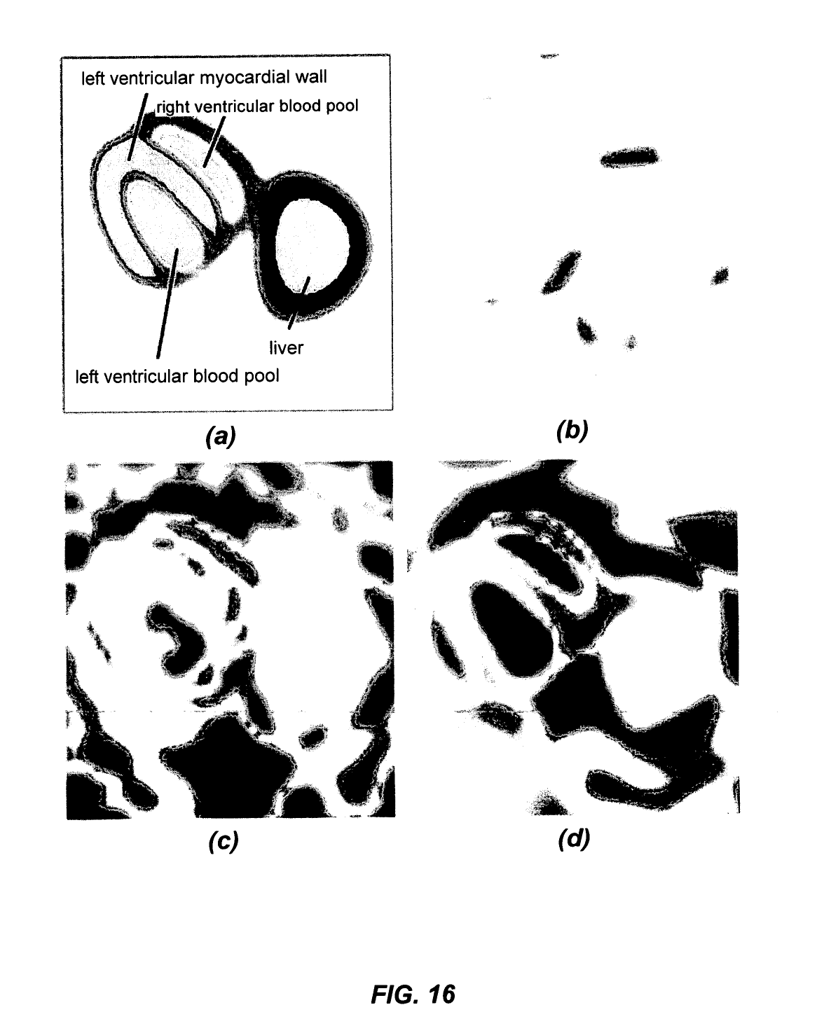

Determination of bias requires 6×2=12 noiseless reconstructions and results are readily available for all voxels in the 64×64×64 PH20 image space and 64×64×20 LEHR image space. FIGS. 16a-16d show bias results for the NFF test slice. Averages over the four ROIs shown in FIG. 16a for all six anatomies are listed in Table 4. Regions of high activity are generally less biased than regions of relatively low activity. It is also apparent that LEHR (30 OSEM iterations) bias performance exceeds that of PH20. LEHR LV and LV blood (pool) image values are within 1% and 10% of object values, respectively, and PH20 LV and LV blood (pool) values are within 10% and 20%-40%, respectively.

TABLE 4

| | LEHR (30 iterations) | | | | PH2O | | | | LEHR (2 iterations) | | | |
|---|---|---|---|---|---|---|---|---|---|---|---|---|
| | | LV | RV | | | LV | RV | | | LV | RV | |
| Phantom | LV | Blood | Blood | Liver | LV | Blood | Blood | Liver | LV | Blood | Blood | Liver |
| NMN | 0.005 | 0.050 | 0.033 | 0.008 | 0.106 | 0.332 | 0.330 | 0.063 | 0.078 | 0.884 | 0.914 | 0.042 |
| NFF | 0.008 | 0.067 | 0.079 | 0.012 | 0.083 | 0.316 | 0.161 | 0.024 | 0.130 | 1.411 | 0.983 | 0.052 |
| SMN | 0.006 | 0.028 | 0.033 | 0.006 | 0.108 | 0.300 | 0.183 | 0.071 | 0.079 | 0.738 | 0.592 | 0.036 |
| SFF | 0.009 | 0.039 | 0.069 | 0.010 | 0.094 | 0.203 | 0.323 | 0.024 | 0.123 | 1.191 | 0.627 | 0.048 |
| LFF | 0.008 | 0.097 | 0.076 | 0.017 | 0.080 | 0.393 | 0.390 | 0.040 | 0.125 | 1.417 | 1.118 | 0.055 |
| NMF | 0.007 | 0.054 | 0.043 | 0.011 | 0.052 | 0.274 | 0.079 | 0.024 | 0.090 | 0.943 | 1.008 | 0.046 |

^{a}left ventricular myocardium
^{b}right ventricle

Bias should correlate inversely with resolution uniformity. FIG. 16c indicates resolution should be approximately uniform within the myocardium with some degradation along the inner LV wall, consistent with an examination of the CRC in these regions.

FIG. 16d shows bias results from LEHR images reconstructed with 2 iterations of OSEM. LV bias performance is comparable to that of PH20 performance; however LV blood and RV blood bias performances are significantly poorer.

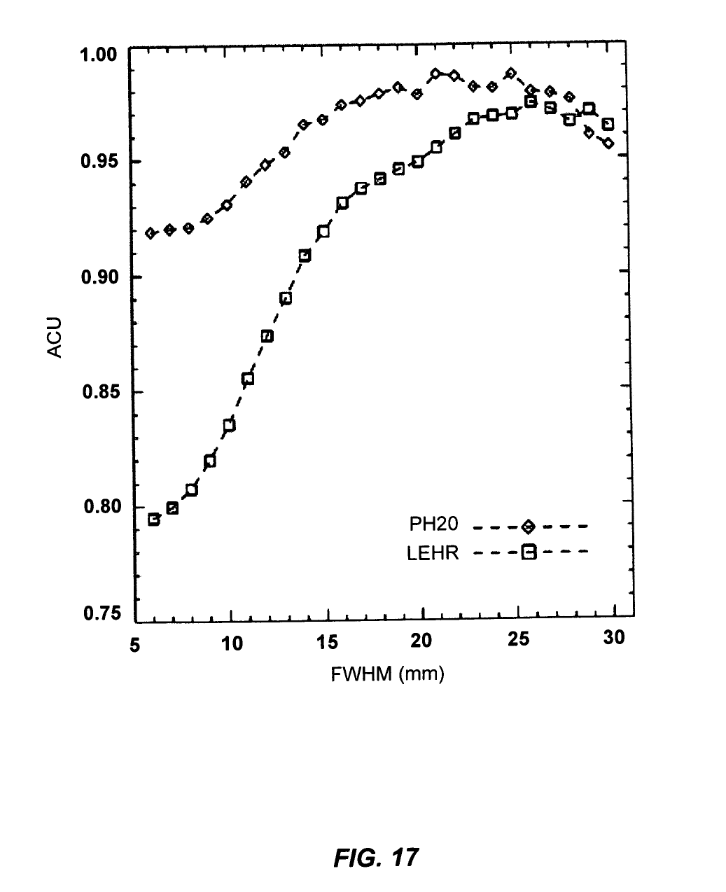

Results of the ROC analysis are shown in FIG. 17. The AUC is presented as a function of resolution. The statistical significance of the differences in AUC was analyzed using the ROCKIT software package (Kurt Rossmann Laboratories for Radiologic Image Research, University of Chicago). At a resolution of 12.5 mm the differences in AUC are statistically significant with a p-value of 0.0067.

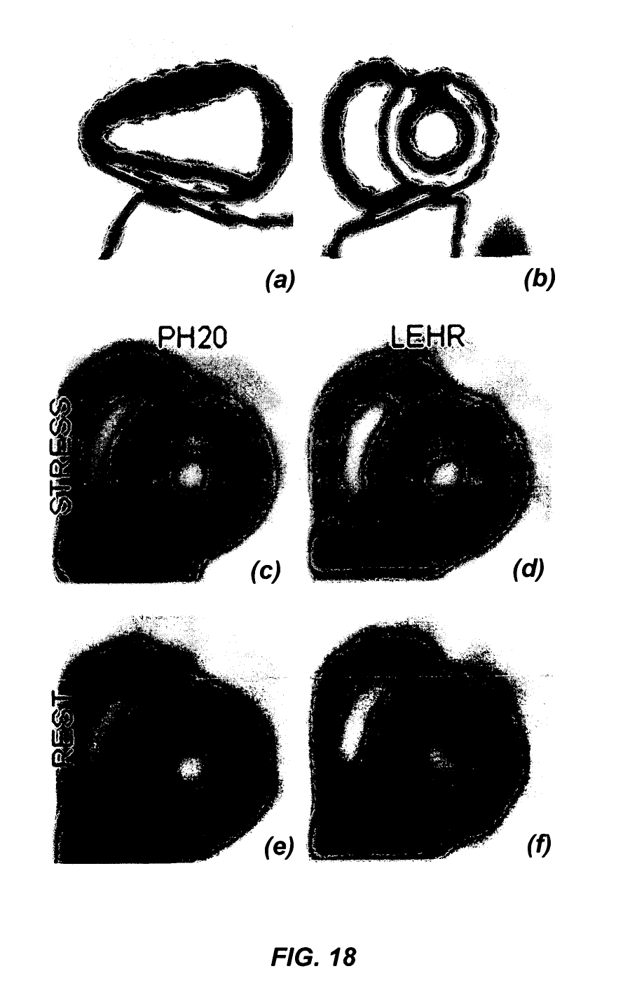

In this section PH20 and LEHR MPI acquisitions with 2 mCi of ^{99m}Tc-sestamibi administered at rest and 6.25 mCi administered at peak stress are simulated and performance assessed. FIGS. 18a-18b show the geometry of the perfusion defect. The angular width of the defect is 30° and spans the entire length of the LV. FIGS. 18c-18f contains reconstructed short-axis slices. Comparison of the PH20 rest and stress images reveals a subtle abnormality. The abnormality is absent in the LEHR images. These results are consistent with both the voxel-based and task-based assessments presented in earlier sections.

The results of this work assume photon detection efficiencies presented if FIG. 1b as calculated by the analytic projector/backprojector pair. Comparisons with MC simulations reveal an overestimation PH20 detection efficiencies by almost 30% and an underestimation of LEHR detection efficiencies by almost 30%. Correcting for these discrepancies would limit the improvement in PH20 SNR to 30%-70%; however, the efficiency of a clinical LEHR collimator for the lnfinia SPECT camera is 0.7×10⁻⁴ (GE Healthcare, St. Chalfont, UK) and the efficiency of the LEHR collimator examined in this example is 1.3×10⁻⁴, or larger than clinical LEHR efficiencies by over 85%. Even if the MC results hold for PH20 detection efficiencies, the relative performances of the collimators in clinical settings are expected to generally follow the major results of this example.

The effects of scatter on the projection data is not considered here. Scatter comprises roughly 30%-35% of the counts in PH20 and LEHR projection data and will result in some degradation of reconstructed image quality. It is anticipated that incorporation of a scatter model into these investigations will lead to further improvements in PH20 SNR and diagnostic performance relative to LEHR collimator performance due to the improved counting statistics in PH20 projection data.

For the patient anatomies investigated PH20 SPECT MPI demonstrates superior noise performance and diagnostic sensitivity over conventional LEHR SPECT MPI. The use of PH20 collimators on current SPECT cameras requires only a simple collimator exchange, an already common procedure performed in SPECT imaging rooms.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example it may be recognized that some radiotracer experiences preferential uptake in a specific organ, e.g. the prostate gland, with little uptake in surrounding tissue and furthermore that the prostate gland is small with projections covering much smaller fractions of the total detector area (relative to the heart and liver, say) and therefore significant magnification (and therefore reconstructed image resolution) is possible by increasing the distance between the aperture plate and the detector with little contribution to the recorded projections from surrounding radioactivity distributions. Further, it may be recognized that a positron emitter with resulting gamma-ray emissions at 511 keV could be used in an optimal manner for imaging applications with these multipinhole collimators with apertures made of dense materials such as depleted uranium considering that large emission fluxes could compensate for increased penetration through the detectors at this energy and furthermore considering that hardware may have been developed that can accommodate large count rates. It is also possible that it is recognized that materials such as tungsten or lead are suitable for such a task if the aperture diameter is made suitably small, for example, smaller than 4 mm. Further, applications on multiple-head SPECT cameras could be envisioned, or use with detector materials other than Sodium Iodide (e.g. Cadmium Zinc Telluride), or dynamic SPECT applications (in addition to the static SPECT studies discussed throughout this document).

All such variations are considered to be within the scope and spirit of the present invention as defined by the following claims and their legal equivalents.

What is claimed:

1. A computed tomography apparatus comprising: a single photon emission computed tomography (SPECT) multi-pinhole collimator, wherein said multi-pinhole collimator comprises an aperture plate and a grid pattern of pinholes disposed in said aperture plate, wherein said pinholes comprise through-holes each having a central axis pointing at a common focal point at a finite distance from said aperture plate.

2. The SPECT multi-pinhole collimator of claim 1, wherein said grid pattern comprises up to 5 pinholes across said aperture plate and up to 4 pinholes down said aperture plate.

3. The SPECT multi-pinhole collimator of claim 1, wherein said pinhole has an aperture diameter in a range of up to 8 mm.

4. The SPECT multi-pinhole collimator of claim 1, wherein said aperture plate is made from material selected from the group consisting of Tungsten, Lead, Platinum, Gold, and Depleted Uranium.

5. The SPECT multi-pinhole collimator of claim 1, wherein said pinholes are i) tapered pinholes, ii) un-tapered pinholes, or i) and ii).

6. The SPECT multi-pinhole collimator of claim 1, wherein said aperture plate comprises a form factor having dimensions that fit into an imaging SPECT scanner.

7. The SPECT multi-pinhole collimator of claim 1, wherein said pinhole is disposed in an aperture plate bore, wherein said aperture plate bore comprises i) a square bore, ii) a cylindrical bore, or i) and ii).

8. The SPECT multi-pinhole collimator of claim 1, wherein said grid pattern of pinholes comprise a field of view disposed to provide a maximum coverage of a surface of a detector.

9. The SPECT multi-pinhole collimator of claim 1, wherein a size of said grid pattern of pinholes is determined according to an aspect ratio of detectors.

10. The SPECT multi-pinhole collimator of claim 1, wherein said SPECT multi-pinhole collimator comprises said pinholes, a pinhole grid size, a focal length and a bore length.

11. The SPECT multi-pinhole collimator of claim 1, wherein said SPECT multi-pinhole collimator operates in the photon energy range of 70 keV to 365 keV.

12. The SPECT multi-pinhole collimator of claim 1, wherein said SPECT multi-pinhole collimator is disposed for radionuclide imaging using nuclear medicine therapies selected from the group consisting of TI-201, Tc-99m, I-123, In-111 and I-131.

13. The SPECT multi-pinhole collimator of claim 12, wherein said radionuclide imaging is selected from the group consisting of brain radionuclide imaging, cardiac radionuclide imaging, bladder radionuclide imaging, thyroid radionuclide imaging, breast radionuclide imaging, prostate gland radionuclide imaging, and adrenal gland radionuclide imaging.

14. The SPECT multi-pinhole collimator of claim 1, wherein said SPECT multi-pinhole collimator is disposed for use in oncology applications.
